(19) United States
(12) Patent Application Publication
(10) Pub. No.: US 2026/0104657 A1
(43) Pub. Date: Apr. 16, 2026

(54) IMAGE FORMING APPARATUS

(71) Applicant: CANON KABUSHIKI KAISHA, Tokyo (JP)

(72) Inventor: Ryosuke Kosone, Chiba (JP)

(21) Appl. No.: 19/311,090

(22) Filed: Aug. 27, 2025

(30) Foreign Application Priority Data
Oct. 15, 2024 (JP) 2024-179625

(51) Int. Cl. G03G 15/06; G03G 15/00; G03G 15/08

(52) U.S. Cl. CPC G03G 15/065; G03G 15/0863; G03G 15/0865; G03G 15/5004; G03G 15/80; G03G 2215/0604

(57) ABSTRACT

An image forming apparatus including: a developing bias application portion that applies a developing bias in which an AC voltage and a DC voltage are superimposed on the developer bearing member in order to develop an electrostatic latent image formed on the image bearing member by the developer carried on the developer bearing member; a toner replenishment container that accommodates a toner to be supplied to the developing container; an acquisition portion that acquires information on a coverage of an external additive carried on a surface of the toner accommodated in the toner replenishment container; and a controller that controls the developing bias application portion based on the information on the coverage acquired by the acquisition portion.

### BACKGROUND

### Field of the Technology

The present disclosure relates to an image forming apparatus.

### Description of the Related Art

In an electrophotographic image forming apparatus, when a latent image formed on a photosensitive drum is developed by a toner by a development device, a part of an external additive which is inorganic fine particles added to the toner is also developed together. Since the external additive developed on the photosensitive drum has a particle size smaller than that of the toner, it is difficult to remove the external additive even through the cleaning device, and the external additive may remain on the photosensitive drum.

In this case, in the region where a large amount of external additive remains on the photosensitive drum, the toner is more easily developed by the electric field formed by the fine particles when reaching the developing portion again. Therefore, when a uniform image such as a halftone image is formed, a density difference may occur due to a difference in the amount of the external additive remaining on the photosensitive drum, and the image may be visually recognized as a ghost image. Such a phenomenon is likely to become apparent in a case where the toner is easily developed, in a case where the charging amount of the external additive is large, in a case where an image of the same or similar pattern is repeatedly formed, or the like.

In such a situation, Japanese Patent Application Laid-Open No. 2019-66547 discloses an image forming apparatus in which a photosensitive drum is rotated in a state where a developing bias applied to a developer holder is set higher than that during image formation, and external additives in a development device are discharged to the photosensitive drum during non-image formation.

Furthermore, in recent years, when it has been attempted to satisfy low-temperature fixability, allowing a toner used in an electrophotographic image forming apparatus to be fixed to a recording medium at a low temperature, there has been a trade-off relationship between low-temperature fixability and durability stability against abrasion of a surface of the toner and the like. On the other hand, Japanese Patent Application Laid-Open No. 2016-139063 discloses a technique for carrying a large amount of external additives on the surface of a toner. This makes it possible to provide a toner having both durability stability and low-temperature fixability.

However, in the conventional image forming apparatus, when the toner production conditions vary depending on the lot at the time of producing the toner, the amount of the external additive carried on the surface of the toner (coverage of external additive) may vary. For example, when the amount of the external additive carried on the surface of the toner increases, the amount of the external additive remaining on the photosensitive drum without being cleaned off also increases, and thus a ghost image becomes apparent due to a difference in the amount of the external additive remaining on the photosensitive drum. On the other hand, when the amount of the external additive carried on the surface of the toner decreases, the toner density is excessively lowered, and the developability of the toner with respect to the photosensitive drum is deteriorated.

### SUMMARY

An object of one aspect of the present disclosure is to suppress the occurrence of image defects even when the coverage of the external additive carried on the surface of the toner varies.

Another object of the present disclosure is to include: an image bearing member; a developing container that accommodates a developer containing a toner; a developer bearing member that carries the developer accommodated in the developing container; a developing bias application portion that applies a developing bias in which an alternating voltage and a direct voltage are superimposed on the developer bearing member in order to develop an electrostatic latent image formed on the image bearing member by the developer carried on the developer bearing member; a toner replenishment container that accommodates a toner to be supplied to the developing container; an acquisition portion that acquires information on a coverage of an external additive carried on a surface of the toner accommodated in the toner replenishment container; and a controller that controls the developing bias application portion based on the information on the coverage acquired by the acquisition portion.

Another object of the present disclosure is to include: an image bearing member; a development device including a developing container that accommodates a developer containing toner and a developer bearing member that carries the developer accommodated in the developing container; a developing bias application portion that applies a developing bias in which an alternating voltage and a direct voltage are superimposed on the developer bearing member in order to develop an electrostatic latent image formed on the image bearing member by the developer carried on the developer bearing member; an acquisition portion that acquires information on a coverage of an external additive carried on a surface of the toner accommodated in the development device; and a controller that controls the developing bias application portion based on the information on the coverage acquired by the acquisition portion.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of an image forming apparatus according to a first embodiment of the present disclosure;

FIG. 2 is a schematic cross-sectional view taken along a plane orthogonal to the axial direction of a developing sleeve of a development device of the image forming apparatus according to the first embodiment of the present disclosure;

FIG. 3 is a schematic cross-sectional view taken along a plane parallel to the axial direction of the developing sleeve of the development device of the image forming apparatus according to the first embodiment of the present disclosure;

FIG. 4 is a block diagram illustrating a configuration of the image forming apparatus according to the first embodiment of the present disclosure;

FIG. 5 is a diagram illustrating a waveform of a developing bias applied to the development device from a developing power supply of the image forming apparatus according to the first embodiment of the present disclosure;

FIG. 6 is a flowchart illustrating developing bias correction processing executed by the image forming apparatus according to the first embodiment of the present disclosure;

FIGS. 7A and 7B are diagrams illustrating an example of an image formed on a sheet in order to detect toner density by a reflective density sensor of the image forming apparatus according to the first embodiment of the present disclosure;

FIG. 8 is a diagram illustrating a density difference between a ghost portion and a non-ghost portion of the image forming apparatus according to the first embodiment of the present disclosure in comparison with a conventional case;

FIG. 9 is a schematic diagram of a developer used in the development device of the image forming apparatus according to the first embodiment of the present disclosure;

FIG. 10 is a perspective view of a developer replenishment container of the image forming apparatus according to the first embodiment of the present disclosure;

FIG. 11 is a diagram illustrating a relationship between an external additive coverage of a single toner and an external additive coverage of a single toner in the development device of the image forming apparatus according to the first embodiment of the present disclosure;

FIG. 12 is a schematic diagram illustrating a configuration of the reflective density sensor of the image forming apparatus according to the first embodiment of the present disclosure;

FIG. 13 is a diagram illustrating a relationship between the external additive coverage of the single toner and a correction value of the developing bias in the image forming apparatus according to the first embodiment of the present disclosure; and

FIG. 14 is a block diagram illustrating a configuration of an image forming apparatus according to a second embodiment of the present disclosure.

### DESCRIPTION OF THE EMBODIMENTS

Hereinafter, embodiments will be described in detail with reference to the drawings.

### First Embodiment

### <Configuration of Image Forming Apparatus>

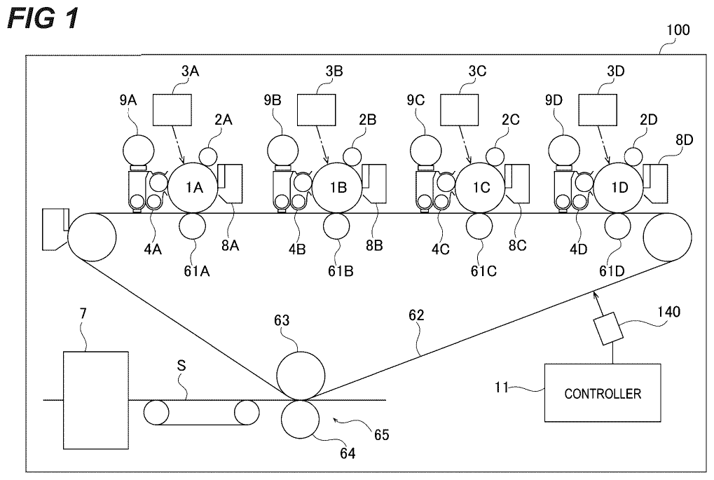

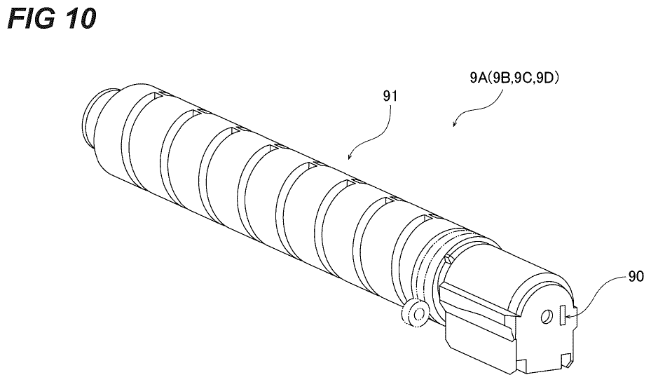

A configuration of an image forming apparatus 100 according to a first embodiment of the present disclosure will be described in detail with reference to FIGS. 1, 4, 10, and 12.

Here, the image forming apparatus 100 is exemplified by a so-called tandem type image forming apparatus provided with a drum cartridge that forms toner images of four colors of yellow, magenta, cyan, and black.

The image forming apparatus 100 includes photosensitive drums 1A, 1B, 1C, and 1D, charging rollers 2A, 2B, 2C, and 2D, exposure devices 3A, 3B, 3C, and 3D, development devices 4A, 4B, 4C, and 4D, and a fixing device 7. In addition, the image forming apparatus 100 includes cleaners 8A, 8B, 8C, and 8D, supply devices 9A, 9B, 9C, and 9D, a controller 11, an operation portion 12, and primary transfer rollers 61A, 61B, 61C, and 61D.

The image forming apparatus 100 includes an intermediate transfer belt 62, a secondary transfer portion 65, a developing bias power supply 81, and a charging bias power supply 82. The image forming apparatus 100 further includes a primary transfer bias power supply 83, a secondary transfer bias power supply 84, a developer replenishment container memory 90, and a reflective density sensor 140.

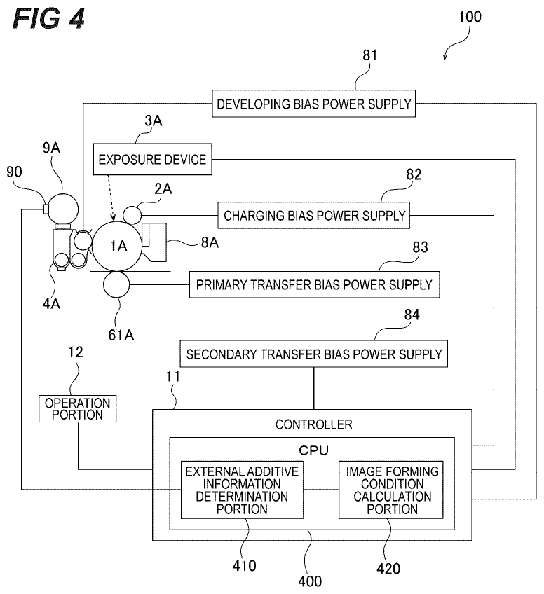

Although the photosensitive drums 1B, 1C, and 1D and the charging rollers 2B, 2C, and 2D are not illustrated in FIG. 4, the photosensitive drums 1B, 1C, and 1D and the charging rollers 2B, 2C, and 2D have the same configuration as the photosensitive drum 1A and the charging roller 2A. The same applies to the exposure devices 3B, 3C, and 3D, the development devices 4B, 4C, and 4D, the cleaners 8B, 8C, and 8D, the supply devices 9B, 9C, and 9D, and the primary transfer rollers 61B, 61C, and 61D.

The photosensitive drums 1A, 1B, 1C, and 1D as image bearing members are charged by the charging rollers 2A, 2B, 2C, and 2D. The photosensitive drums 1A, 1B, 1C, and 1D are irradiated with laser light by the exposure devices 3A, 3B, 3C, and 3D to form electrostatic latent images, and are developed by the development devices 4A, 4B, 4C, and 4D to form toner images.

The charging rollers 2A, 2B, 2C, and 2D are in contact with the surfaces of the photosensitive drums 1A, 1B, 1C, and 1D. The charging rollers 2A, 2B, 2C, and 2D uniformly charge the surfaces of the photosensitive drums 1A, 1B, 1C, and 1D by applying a DC voltage as a charging bias from the charging bias power supply 82. The charging rollers 2A, 2B, 2C, and 2D are rubber rollers that rotate following the rotation of the photosensitive drums 1A, 1B, 1C, and 1D.

The exposure devices 3A, 3B, 3C, and 3D are laser scanners, and form electrostatic latent images by irradiating the surfaces of the photosensitive drums 1A, 1B, 1C, and 1D with laser light in accordance with image information of a separated color input from the controller 11.

The development devices 4A, 4B, 4C, and 4D develop the electrostatic latent images formed on the photosensitive drums 1A, 1B, 1C, and 1D with toner by applying a developing bias from the developing bias power supply 81 to form toner images on the photosensitive drums 1A, 1B, 1C, and 1D. Details of the configurations of the development devices 4A, 4B, 4C, and 4D will be described later.

The fixing device 7 fixes the toner image on a sheet S as a recording material to which the toner image is secondarily transferred by the secondary transfer portion 65 and conveyed, by heating and pressurizing the sheet S. The fixing device 7 discharges the sheet S on which the toner image has been fixed to the outside of the image forming apparatus 100.

The cleaners 8A, 8B, 8C, and 8D remove residual toner remaining on the photosensitive drums 1A, 1B, 1C, and 1D after the primary transfer.

The supply devices 9A, 9B, 9C, and 9D as toner replenishment containers contain the developer, and replenish the development devices 4A, 4B, 4C, and 4D with the developer. The supply devices 9A, 9B, 9C, and 9D each include a developer replenishment container 91.

A developer containing at least toner is enclosed and stored in the developer replenishment container 91 as a toner replenishment container. The developer replenishment container 91 is detachably attached to the image forming apparatus 100. When the developer replenishment container 91 is attached to the image forming apparatus 100, the enclosed developer is discharged from a discharge hole (not illustrated) and supplied to the development devices 4A, 4B, 4C, and 4D. The developer replenishment container 91 is provided with the developer replenishment container memory 90.

The controller 11 as a control unit controls the entire operation of the image forming apparatus 100. The controller 11 executes a patch detection density control processing in order to accurately reproduce the input image to the output image, and suitably changes the image forming condition when the image is formed on the sheet S.

Specifically, the controller 11 calculates a differential light quantity between the light quantity of the reflected light from the surface of the intermediate transfer belt 62 and the light quantity of the reflected light from a toner patch T provided on the outer peripheral surface of the intermediate transfer belt 62 based on the electric signal input from the reflective density sensor 140. The controller 11 detects the toner adhesion amount of the toner patch T based on the calculated differential light quantity, and determines the light quantity of the laser emitted from the exposure devices 3A, 3B, 3C, and 3D during the image forming processing based on the detection result of the toner adhesion amount of the toner patch T. Details of the patch detection density control processing will be described later.

The controller 11 executes a developing bias correction processing to be described later, thereby controlling the developing bias power supply 81 at the time of image formation to correct the developing bias applied from the developing bias power supply 81 to the developing sleeve 41. The controller 11 also executes the above patch detection density control processing in the developing bias correction processing.

The controller 11 includes a CPU 400 that performs arithmetic processing by reading and executing a control program stored in a memory (not illustrated).

The CPU 400 includes an external additive information determination portion 410 and an image forming condition calculation portion 420 configured as functional blocks at the time of execution of the control program.

The external additive information determination portion 410 acquires toner specific information stored in the developer replenishment container memory 90 of the developer replenishment container 91 by reading the toner specific information via an information reading portion (not illustrated) of the image forming apparatus 100.

The image forming condition calculation portion 420 corrects the developing bias applied from the developing bias power supply 81 to the developing sleeve 41 at the time of image formation based on the information acquired by the external additive information determination portion 410. The image forming condition calculation portion 420 executes the patch detection density control processing after correcting the developing bias.

The operation portion 12 is an input/output device such as a touch panel that operates under the control of the controller 11, receives an operation by the user, and outputs an electric signal corresponding to the received operation to the controller 11.

The primary transfer rollers 61A, 61B, 61C, and 61D are disposed to face the photosensitive drums 1A, 1B, 1C, and 1D via the intermediate transfer belt 62, and are in contact with the intermediate transfer belt 62. The primary transfer rollers 61A, 61B, 61C, and 61D primarily transfer the toner images formed on the photosensitive drums 1A, 1B, 1C, and 1D to the intermediate transfer belt 62 by applying a primary transfer bias from the primary transfer bias power supply 83.

The intermediate transfer belt 62 is in contact with the photosensitive drums 1A, 1B, 1C, and 1D to form a primary transfer portion with the photosensitive drums 1A, 1B, 1C, and 1D. The toner images formed on the photosensitive drums 1A, 1B, 1C, and 1D are primarily transferred to the intermediate transfer belt 62 by the primary transfer rollers 61A, 61B, 61C, and 61D in the primary transfer portion. Specifically, when a primary transfer bias having a positive polarity is applied to the intermediate transfer belt 62 by the primary transfer rollers 61A, 61B, 61C, and 61D, toner images having negative polarities on the photosensitive drums 1A, 1B, 1C, and 1D are sequentially transferred in a multiple manner. The toner patch T is formed on the outer peripheral surface of the intermediate transfer belt 62.

The secondary transfer portion 65 secondarily transfers the toner image primarily transferred to the intermediate transfer belt 62 to the sheet S fed by a feeding portion (not illustrated), and conveys the sheet S on which the toner image is secondarily transferred to the fixing device 7. A secondary transfer inner roller 63 and a secondary transfer outer roller 64 are provided.

The secondary transfer inner roller 63 nips and conveys the sheet S fed by the feeding portion together with the secondary transfer outer roller 64.

The secondary transfer outer roller 64 secondarily transfers the full-color toner image formed on the intermediate transfer belt 62 to the sheet S fed by the feeding portion when the secondary transfer bias is applied from the secondary transfer bias power supply 84 of the positive polarity.

The developing bias power supply 81 as a developing bias application portion applies a developing bias to the developing sleeves 41 of the development devices 4A, 4B, 4C, and 4D under the control of the controller 11.

Under the control of the controller 11, the charging bias power supply 82 applies a DC voltage as a charging bias to the charging rollers 2A, 2B, 2C, and 2D to charge the photosensitive drums 1A, 1B, 1C, and 1D via the charging rollers 2A, 2B, 2C, and 2D.

The primary transfer bias power supply 83 applies a primary transfer bias to the primary transfer rollers 61A, 61B, 61C, and 61D under the control of the controller 11.

The secondary transfer bias power supply 84 applies a secondary transfer bias to the secondary transfer outer roller 64 under the control of the controller 11.

The developer replenishment container memory 90 as a storage portion is provided in the developer replenishment container 91 for each color of toner stored in each of the developer replenishment containers 91 of the supply devices 9A, 9B, 9C, and 9D. Here, the mounting position of the developer replenishment container memory 90 with respect to the developer replenishment container 91 is illustrated on the front side of the developer replenishment container 91. The developer replenishment container memory 90 is an IC chip, a bar code, or the like.

The developer replenishment container memory 90 can communicate with an information reading portion (not illustrated) as an acquisition portion of the image forming apparatus 100 when the developer replenishment container 91 is attached to the apparatus body of the image forming apparatus 100. In the developer replenishment container memory 90, data is read and written by the CPU 400 of the controller 11 via the information reading portion. The developer replenishment container memory 90 stores information specific to the toner contained in each developer replenishment container 91.

The information unique to the toner is read and acquired by the information reading portion of the image forming apparatus 100, is output from the information reading portion, and is input to the external additive information determination portion 410 of the CPU 400. Here, the information specific to the toner is information such as the date of manufacture of the toner, the lot at the time of manufacture of the toner, the characteristics of the external additive, and the coverage (hereinafter, described as “toner external additive coverage”) of the external additive carried on the surface of the toner. The information specific to the toner of the present embodiment includes at least information on the external additive coverage of the toner. The charging polarity of the external additive is the same as the charging polarity of the toner.

The information on the external additive coverage of the toner is information on the coverage of the external additive of the single toner for each lot at the time of manufacturing measured in advance in the manufacturing stage of the toner stored in the developer replenishment container 91. The developer replenishment container memory 90 attached to the developer replenishment container 91 filled with the toner of the same lot stores information on the external additive coverage of the same toner.

Note that the developer replenishment container memory 90 is not limited to the IC chip and the barcode, and may be a non-volatile memory other than the IC chip and the barcode capable of automatically reading data by the information reading portion of the image forming apparatus 100.

The reflective density sensor 140 is used to control the toner adhesion amount for accurately reproducing the input image to the output image. The reflective density sensor 140 is disposed at the center of the intermediate transfer belt 62 in the main scanning direction. The reflective density sensor 140 receives reflected light when the outer peripheral surface of the intermediate transfer belt 62 and the toner patches T formed on the outer peripheral surface of the intermediate transfer belt 62 are irradiated with light, and outputs an electric signal of a voltage value corresponding to the quantity of the received reflected light to the controller 11.

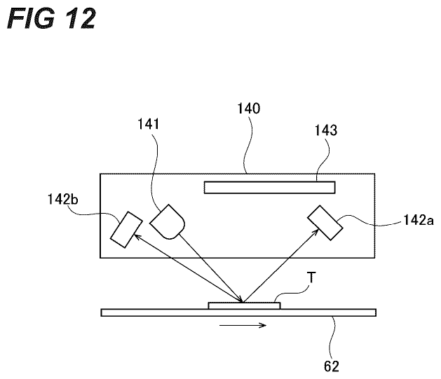

As illustrated in FIG. 12, the reflective density sensor 140 includes a light emitting portion 141, a light receiving portion 142a, a light receiving portion 142b, and an IC 143.

The light emitting portion 141 is an LED or the like. The light emitting portion 141 is installed at an angle of 45 degrees with respect to the normal line of the intermediate transfer belt 62, and irradiates the outer peripheral surface of the intermediate transfer belt 62 and the toner patch T with light at the light quantity level controlled by the IC 143.

The light receiving portion 142a is installed at a position symmetrical to the light emitting portion 141 with respect to the normal line of the intermediate transfer belt 62. The light receiving portion 142a is a photodiode or the like that receives specular reflection light when the light emitting portion 141 irradiates the outer peripheral surface of the intermediate transfer belt 62 and the toner patch T with light, and outputs an electric signal of a voltage value corresponding to the quantity of the received specular reflection light to the controller 11. The light quantity of the reflected light received by the light receiving portion 142a increases as the light emission quantity of the light emitting portion 141 increases.

The light receiving portion 142b is installed on the light emitting portion 141 side with respect to the normal line of the intermediate transfer belt 62, and is installed at an angle of 60 degrees with respect to the normal line. The light receiving portion 142b is a photodiode or the like that receives diffuse reflection light when the light emitting portion 141 irradiates the outer peripheral surface of the intermediate transfer belt 62 and the toner patch T with light, and outputs an electric signal of a voltage value corresponding to the quantity of the received diffuse reflection light to the controller 11. The light quantity of the reflected light received by the light receiving portion 142b increases as the light emission quantity of the light emitting portion 141 increases.

The IC 143 adjusts the voltage applied to the light emitting portion 141 under the control of the controller 11, thereby controlling the quantity of light emitted from the light emitting portion 141 so as to have a light quantity level suitable for detecting the toner density of the toner patch T.

In the image forming apparatus 100 having the above configuration, the developer enclosed in the developer replenishment container 91 includes the same toner and carrier as the developer enclosed in the development devices 4A, 4B, 4C, and 4D. The developer enclosed in the developer replenishment container 91 is manufactured by mixing a toner and a carrier so as to have a carrier density of 9 wt %. On the other hand, the developers enclosed in the development devices 4A, 4B, 4C, and 4D are manufactured by mixing the toner and the carrier so as to have a toner density of 10 wt %.

### <Configuration of Development Device>

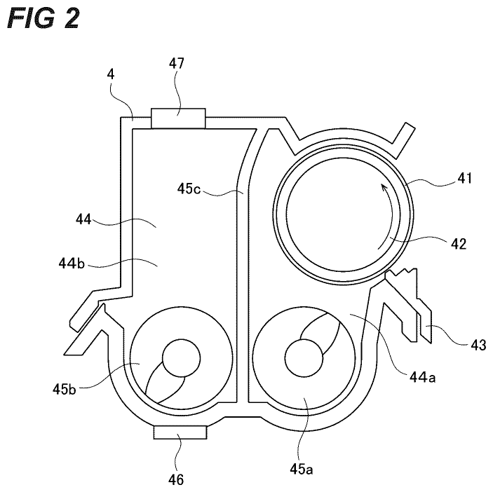

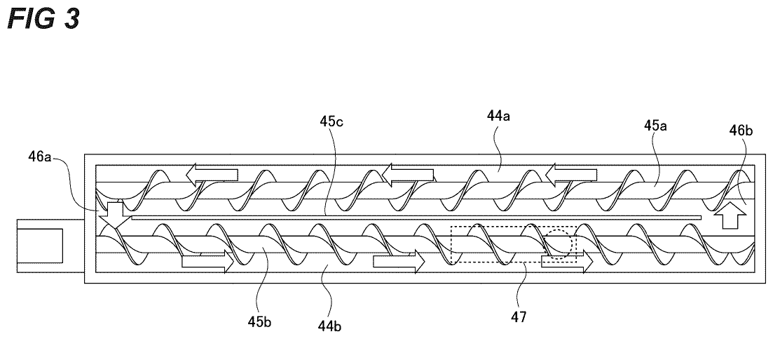

The configurations of the development devices 4A, 4B, 4C, and 4D of the image forming apparatus 100 according to the first embodiment of the present disclosure will be described in detail with reference to FIGS. 2 and 3. Arrows in FIG. 3 indicate moving directions of the developer when the developer circulates through the development devices 4A, 4B, 4C, and 4D.

Each of the development devices 4A, 4B, 4C, and 4D includes a developing sleeve 41, a magnetic field generation portion 42, a regulating member 43, and a developing container 44. Each of the development devices 4A, 4B, 4C, and 4D includes a first screw 45a, a second screw 45b, a first communication portion 46a, a second communication portion 46b, and a developer receiving port 47.

The developing sleeve 41 as a developer bearing member is formed of a non-magnetic material, and rotates at a predetermined process speed (circumferential velocity) during a developing operation. The developing sleeve 41 carries and conveys the developer stored in a developing chamber 44a by the magnetic field generated by the magnetic field generation portion 42, and supplies the carried and conveyed developer to the surfaces of the photosensitive drums 1A, 1B, 1C, and 1D by applying a developing bias from the developing bias power supply 81.

The magnetic field generation portion 42 is provided inside the developing sleeve 41 and generates a magnetic field to carry the developer on the surface of the developing sleeve 41.

The regulating member 43 regulates the height of the magnetic brush formed on the developing sleeve 41.

The developing container 44 stores a developer. The developing container 44 is partitioned into a developing chamber 44a and a stirring chamber 44b by a partition wall 44c extending in the vertical direction.

The first screw 45a is disposed in the developing chamber 44a. The first screw 45a stirs and conveys the developer in the developing chamber 44a.

The second screw 45b is disposed in the stirring chamber 44b. The second screw 45b stirs and conveys the toner supplied from a toner supply member (not illustrated) and the developer in the stirring chamber 44b, thereby making the toner density in the stirring chamber 44b uniform.

The first communication portion 46a is formed in the partition wall 44c, and communicates the developing chamber 44a and the stirring chamber 44b at one end portion in the width direction orthogonal to the conveying direction of the sheet S. The first communication portion 46a delivers the developer from the developing chamber 44a to the stirring chamber 44b.

The second communication portion 46b is formed in the partition wall 44c, and communicates the developing chamber 44a and the stirring chamber 44b at the other end in the width direction. The second communication portion 46b delivers the developer from the stirring chamber 44b to the developing chamber 44a.

The developer receiving port 47 communicates the stirring chamber 44b with the outside. The developer receiving port 47 is capable of supplying the developer, which is enclosed in the developer replenishment container 91 of the supply devices 9A, 9B, 9C, and 9D and is discharged from a discharge hole (not illustrated) of the developer replenishment container 91, to the stirring chamber 44b.

In the development devices 4A, 4B, 4C, and 4D having the above configuration, the first screw 45a and the second screw 45b convey the developer in opposite directions along the rotational axis direction of the developing sleeve 41. The first communication portion 46a transfers the developer from the developing chamber 44a to the stirring chamber 44b, and the second communication portion 46b transfers the developer from the stirring chamber 44b to the developing chamber 44a. As a result, the developer circulates through the developing container 44 in the order of the stirring chamber 44b, the second communication portion 46b, the developing chamber 44a, and the first communication portion 46a.

In addition, due to the conveying force of the first screw 45a and the second screw 45b, the developer in the developing chamber 44a whose toner density has decreased due to the toner consumed in the developing processing moves into the stirring chamber 44b via the first communication portion 46a.

### <Configuration of Developer>

A configuration of a developer used by the image forming apparatus 100 according to the first embodiment of the present disclosure will be described in detail.

The developer stored in the development devices 4A, 4B, 4C, and 4D is a two-component developer in which a negatively charged non-magnetic toner and a magnetic carrier are mixed.

The magnetic carrier is obtained by applying resin coating to a surface layer of a core including ferrite particles and resin particles obtained by kneading magnetic powder. As the magnetic carrier, for example, surface-oxidized or surface-unoxidized iron, nickel, cobalt, manganese, chromium, rare earth, an alloy of these metals, or oxide ferrite can be suitably used. A method for producing these magnetic particles is not particularly limited. Here, as the magnetic carrier, ferrite particles coated with a silicone resin are exemplified.

The magnetic carrier has a saturation magnetization of 294 am2/kg with respect to an applied magnetic field of 240 kA/m, and a specific resistance of 1×107˜8 Ω·cm at an electric field intensity of 3000 V/cm. The magnetic carrier is not limited to the above, and may be a resin magnetic carrier produced by a polymerization method using a binder resin, a magnetic metal oxide, and a non-magnetic metal oxide as starting materials.

The magnetic carrier is measured by dividing a range of a particle size of 0.5 to 350 μm into 32 logarithmic intervals on a volume basis using a laser diffraction particle size distribution measuring apparatus HEROS (manufactured by JEOL Ltd.), and the number of particles in each channel is measured. Then, from the measurement result of the number of particles, a median diameter of 50% in volume is defined as the volume average particle diameter of the magnetic carrier. The volume average particle size of the magnetic carrier is exemplified here as 50 μm.

The non-magnetic toner contains a colorant, a wax component, and the like in a resin such as polyester or styrene, and is formed into a powder by pulverization or polymerization.

The non-magnetic toner is composed of at least a binder resin, a colorant, and a charge control agent. Here, a styrene acrylic resin is exemplified as the binder resin, but the binder resin is not limited to the styrene acrylic resin, and a styrene-based resin, a polyester-based resin, or a polyethylene resin can also be used.

Here, phthalocyanine blue is exemplified as the colorant, but the colorant is not limited to phthalocyanine blue, and carbon black, chrome yellow, Hansa yellow, benzidine yellow, slen yellow, and quinoline yellow can be used. In addition, permanent orange GTR, pyrazolone orange, Vulcan orange, watchung red, permanent red, brillian carmine 3B, brillian carmine 6B, DuPont oil red, and pyrazolone red can be used.

In addition, lithol red, rhodamine B lake, lake red C, rose bengal, aniline blue, and ultramarine blue can be used. Furthermore, calco oil blue, methylene blue chloride, phthalocyanine green, malachite green oxalerate, or the like can be used.

As described above, various pigments, various dyes, or the like can be used as the colorant. As the colorant, only one of the above colorants may be used, or a plurality of colorants may be used in combination.

The charge control agent may contain a charge control agent for reinforcement as necessary. As the charge control agent for reinforcement, all known ones can be used, and examples thereof include nigrosine-based dyes, triphenylmethane-based dyes, chromium-containing metal complex dyes, molybdate chelate pigments, rhodamine-based dyes, and alkoxy-based amines. Alternatively, examples thereof include a quaternary ammonium salt (including fluorine-modified quaternary ammonium salt), an alkylamide, a phosphorus simple substance or compound, a tungsten simple substance or compound. Alternatively, examples thereof include a fluorine-based surfactant, a salicylic acid metal salt, a metal salt of a salicylic acid derivative, or the like.

The non-magnetic toner may contain a wax or an external additive. The wax is contained for improving toner parting properties and fixability from and to the fixing member at the time of fixing.

As the wax, paraffin wax, carnauba wax, polyolefin, or the like can be used. The wax is kneaded and dispersed in the binder resin. Here, as the non-magnetic toner, a resin obtained by kneading and dispersing a binder, a colorant, a charge control agent, and wax is pulverized by a mechanical pulverizer.

Examples of the external additive include fine particles formed by subjecting amorphous silica to a hydrophobic treatment, or inorganic oxide fine particles such as titanium oxide or a titanium compound. The external additive is externally added to the base of the toner to control the powder fluidity and the charging amount of the toner. The particle size of the external additive particles is desirably about 1 nm to 100 nm. In this example, titanium oxide having an average particle size of 50 nm was externally added in a weight ratio of 0.5 wt %, and amorphous silica having average particle sizes of 2 nm and 100 nm were externally added in an amount of 0.5 wt % and 1.0 wt %, respectively.

The particle diameter of the toner having the above configuration was measured with a powder particle size image analyzer FPIA-3000 manufactured by Sysmex Corporation, and the volume average particle diameter was 6.0 μm. The cohesion of the toner was 30 as measured with a powder tester manufactured by Hosokawa Micron Corporation. The external additive coverage of the toner was 60% as measured using ESCA. Here, the external additive coverage of the toner can be determined by the following formula (1).

$$External additive coverage of toner ( \% ) = ( SG / ST ) \times 100 \qquad ( 1 )$$

Here, SG represents the area of the external additive portion added to the toner particles.

ST represents the area of the surface portion of the toner particle including the area (SG) of the external additive portion.

The external additive coverage of the toner is measured by ESCA (X-ray photoelectron spectroscopy), and is calculated from the atomic amount of silica-derived silicon (hereinafter, described as “Si”) present on the toner particle surface. ESCA is an analysis method for detecting atoms in a region of several nm or less in a depth direction of a sample surface. Therefore, it is possible to detect atoms on the surface of the toner. As the sample holder, a 75 mm square platen (provided with screw hole having a diameter of about 1 mm for fixing sample) attached to the apparatus was used. Since the screw hole of the platen penetrated, the screw hole was closed with a resin or the like to prepare a recess for powder measurement having a depth of about 0.5 mm. The measurement sample was packed in the recess with a spatula or the like and scraped to prepare a sample.

The ESCA apparatus and measurement conditions are as follows.
Apparatus used: PHI5000 VersaProbeIl manufactured by ULVAC-PHI, Inc.
Analysis method: narrow analysis
X-ray source: Al-Kα
X-ray conditions: 100 μm 25 W 15 kV
Photoelectron take-in angle: 45
PassEnergy: 58.70 eV
Measurement range: 300 μm×200 μm

In the analysis method, first, the peak derived from the C—C bond of the carbon 1s orbital is corrected to 285 eV. Thereafter, the amount of Si derived from silica with respect to the total amount of constituent elements is calculated from the peak area derived from the Si 2p orbital in which the peak top is detected at 100 eV or more and 105 eV or less by using the relative sensitivity factor provided by ULVAC-PHI. Next, the silica alone applied to the toner is measured by the same method as described above, the amount of Si derived from silica with respect to the total amount of constituent elements is calculated, and the silica coverage, which is the ratio of the amount of Si when the toner is measured to the amount of Si when the external additive alone is measured, is taken as the external additive coverage of the toner.

In the present embodiment, 200 g of the developer obtained by mixing the toner and the carrier so as to have a mixing ratio (toner density) of 10 wt % was charged into the development devices 4A, 4B, 4C, and 4D. In the present embodiment, the silica coverage at the center of the variation in mass production of the single toner is set to 60%.

### <Ghost Image>

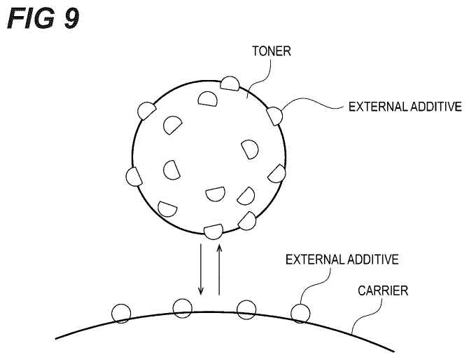

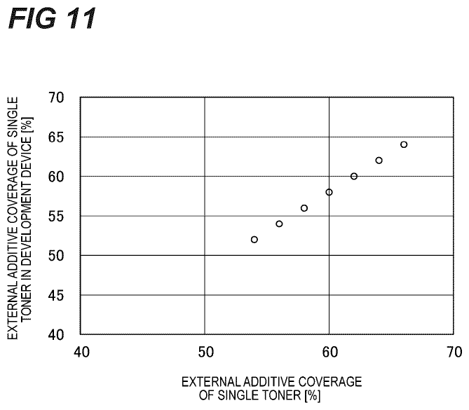

A ghost image generated at the time of image formation in the image forming apparatus 100 according to the first embodiment of the present disclosure will be described in detail with reference to FIGS. 9 and 11.

The developer used in the image forming apparatus 100 is a dry two-component developer containing a toner to which an external additive, which is fine particles having a negative polarity having the same polarity as the charging polarity of the toner, is added, and a carrier. In a developing processing of developing such a developer according to the electrostatic latent images formed on the photosensitive drums 1A, 1B, 1C, and 1D, toner of the developer carried on the developing sleeve 41 in the development devices 4A, 4B, 4C, and 4D is mainly developed in an image portion (bright area potential portion of electrostatic latent image). At this time, the external additive added to the toner is also simultaneously developed.

In addition, a part of the external additive added to the toner is stirred in the development devices 4A, 4B, 4C, and 4D, so that the adhesive force with the toner is reduced and separated from the toner. Here, in the two-component developer including the toner and the carrier, as illustrated in FIG. 9, the external additive carried on the surface of the toner is separated from the toner and transferred to the carrier by the contact between the toner and the carrier. In the two-component developer, the total amount of the external additive is shared by the toner and the carrier, and a certain equilibrium relationship is established.

For example, as illustrated in FIG. 11, in a case where the external additive coverage of the toner is 60%, in a case where the toner density of the developer including the toner and the carrier is 10%, the external additive coverage of the toner in the development devices 4A, 4B, 4C, and 4D is 58%. This indicates that 2% of the toner external additive coverage of 60% has transferred to the surface of the carrier.

Since the external additive added to the toner has a negative polarity similarly to the toner, the external additive is easily developed in the image portion. Therefore, the developing amount of the external additive is larger in the image portions on the photosensitive drums 1A, 1B, 1C, and 1D than in the non-image portions on the photosensitive drums 1A, 1B, 1C, and 1D.

The toner and the external additive developed on the photosensitive drums 1A, 1B, 1C, and 1D are primarily transferred onto the intermediate transfer belt 62 in the transfer processing. On the other hand, part of the toner and the external additive having a small particle size and a large non-electrostatic adhesion force remain on the photosensitive drums 1A, 1B, 1C, and 1D without being transferred onto the intermediate transfer belt 62.

Next, the transfer residual toner remaining on the photosensitive drums 1A, 1B, 1C, and 1D that have reached the cleaning processing is cleaned off by a cleaning member. On the other hand, the external additive remaining on the photosensitive drums 1A, 1B, 1C, and 1D that has reached the cleaning processing has a small particle size and a large adhesion force with the photosensitive drums 1A, 1B, 1C, and 1D, and thus cannot be cleaned and remains on the photosensitive drums 1A, 1B, 1C, and 1D as it is.

Next, the external additive remaining on the photosensitive drums 1A, 1B, 1C, and 1D and reaching the charging processing forms an electric field in a direction of drawing toner between the external additives by the negative polarity of the external additive itself and the negative charge received by the charging voltage applied by the charging rollers 2A, 2B, 2C, and 2D. In the portions of the photosensitive drums 1A, 1B, 1C, and 1D to which the external additives adhere, the adhesion to the toner is increased by the electric field, so that the toner is more easily developed at the time of the next image formation.

In the image portions on the photosensitive drums 1A, 1B, 1C, and 1D, when the same or similar image pattern is continuously formed, the above-described processing is continuously performed, and thus the accumulation amount of the external additive increases, so that the developing amount of the toner increases. As a result, when a uniform image such as a halftone image is formed, a density difference occurs in the image portion, and the image portion is visually recognized as a so-called ghost on the image.

As described above, the easiness of the occurrence of the ghost is caused by the easiness of developing of the toner due to the difference in the accumulation amount of the external additive remaining on the photosensitive drums 1A, 1B, 1C, and 1D. Therefore, since the developer having a large external additive ratio is frequently supplied into the development devices 4A, 4B, 4C, and 4D, the density of the external additive of the developer in the development devices 4A, 4B, 4C, and 4D excessively increases. As a result, a large amount of external additive is developed together with the toner, and the risk of occurrence of the ghost image is increased. That is, the risk of occurrence of the ghost image increases as the amount of external additive contained in the toner increases.

In the present embodiment, when the external additive coverage of the toner in the developer in the development devices 4A, 4B, 4C, and 4D becomes 61% or more, the amount of the external additive attached to the photosensitive drums 1A, 1B, 1C, and 1D becomes excessive, and the ghost image becomes apparent. On the other hand, when the external additive coverage of the toner in the developer in each of the development devices 4A, 4B, 4C, and 4D is 58% at the center of variation in mass production, the ghost image does not occur.

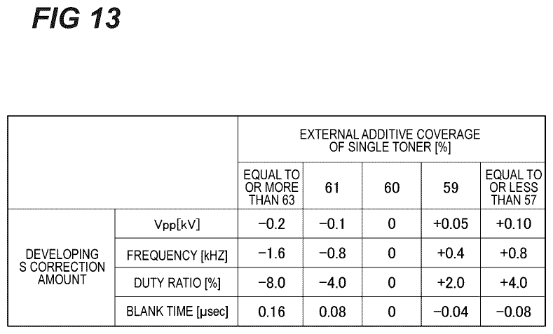

However, in the toner manufacturing processing, the external additive coverage of the toner varies depending on variations in manufacturing conditions. Specifically, the external additive coverage of the toner varies in a range of 56 to 64% in the developer having a toner density of 10% as illustrated in FIG. 13, and exceeds 61% which is a threshold value at which the ghost image occurs. When the external additive coverage of the toner exceeds 61%, the external additive coverage may become apparent as an abnormal image.

In the image forming apparatus 100 according to the present embodiment, it is possible to reduce the ghost caused by the density difference caused by the accumulation amount of the external additive remaining on the photosensitive drums 1A, 1B, 1C, and 1D as described above.

### <Developing Bias>

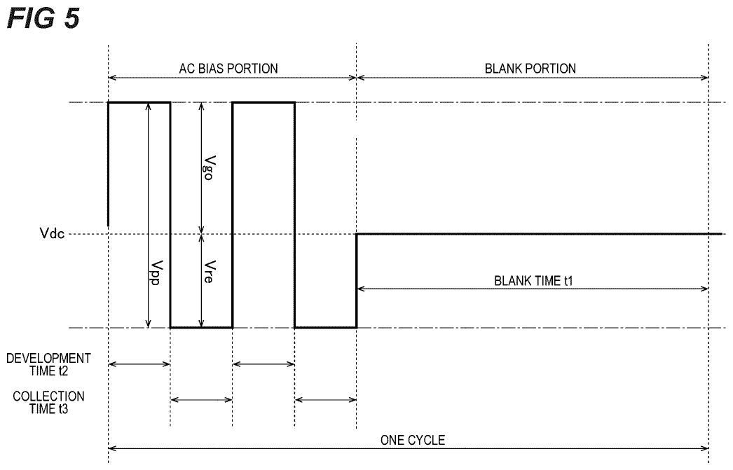

The developing biases applied from the developing bias power supply 81 of the image forming apparatus 100 according to the first embodiment of the present disclosure to the development devices 4A, 4B, 4C, and 4D will be described in detail with reference to FIG. 5.

FIG. 5 illustrates a waveform of the developing bias output from the developing bias power supply 81 at the time of image formation in which toner is caused to fly to the photosensitive drums 1A, 1B, 1C, and 1D.

The developing bias power supply 81 applies, to the developing sleeve 41, a developing bias in which an AC component (AC voltage) and a DC component (DC voltage) are superimposed. The alternating current component of the developing bias is a rectangular wave of 11 kHz. In addition, the developing bias is provided with a blank portion in which the AC component is intermittently omitted to leave only the DC component. Note that a pulse of a rectangular wave existing in a portion corresponding to the blank portion when the AC component is not thinned out, in other words, a pulse that becomes blank by thinning out the AC component (pulse that no longer exists) is referred to as a “blank pulse”.

Therefore, the developing bias output from the developing bias power supply 81 has a waveform in which an AC bias portion in which a DC component Vdc is superimposed on the AC component and a blank portion including only the DC component Vdc subsequent to the AC bias portion are set as one cycle. The blank portion has lower developability than the AC bias portion. As illustrated in FIG. 5, the developing bias power supply 81 outputs, as a developing bias, a double blank pulse waveform (referred to as “WBP”) in which a blank portion is provided after an AC bias portion of a rectangular wave of two pulses.

Note that the number of pulses of the rectangular wave in the AC bias portion is assumed to count a half cycle of the rectangular wave as one pulse. The time of the blank portion in one cycle of the developing bias is defined as a blank time t1. In addition, the total time during which an electric field (pulse) Vgo on the development side (developer application side) of the AC bias portion is generated in one cycle of the developing bias is defined as a development time t2. In addition, the total time during which an electric field Vre on the developer collecting side (developer returning side) is generated in one cycle of the developing bias is defined as a collection time t3. In addition, the total voltage of the developing side voltage Vgo and the developer collecting side voltage Vre in the AC bias portion is defined as a peak-to-peak voltage Vpp. The peak-to-peak voltage Vpp is exemplified here as 1.40 kV. Here, one cycle of the developing bias is 1 sec.

Here, the electric field Vgo on the development side is an electric field in which the toner flies from the developing sleeve 41 side to the photosensitive drums 1A, 1B, 1C, and 1D side by the AC bias portion in one cycle of the developing bias. The electric field Vre on the developer collecting side is an electric field in which the toner is drawn back from the photosensitive drums 1A, 1B, 1C, and 1D side to the developing sleeve 41 side by the AC bias portion in one cycle of the developing bias. In the present embodiment, a duty ratio, which is the ratio (Vgo/(Vgo+Vre)) between the electric field Vgo on the development side and the electric field Vre on the developer collecting side, is set to 60%.

### <Developing Bias Correction Processing>

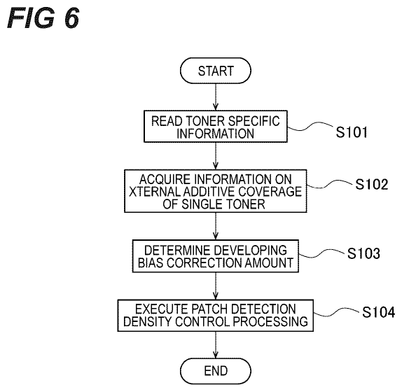

The developing bias correction processing executed by the image forming apparatus 100 according to the first embodiment of the present disclosure will be described in detail with reference to FIGS. 5 and 6.

The CPU 400 corrects the developing bias applied at the time of image formation by controlling the developing bias power supply 81 based on the toner specific information stored in the developer replenishment container memory 90. Specifically, the CPU 400 can obtain the external additive coverage of the toner to be supplied to the development devices 4A, 4B, 4C, and 4D from the information on the external additive coverage of the toner stored in the developer replenishment container memory 90. As a result, the CPU 400 can determine whether or not a ghost image occurs due to variation for each lot at the time of manufacturing the toner.

Then, in a case where the CPU 400 determines that a ghost image occurs due to variation for each lot at the time of manufacturing the toner, the CPU 400 performs correction so that the flying amount of the toner to the photosensitive drums 1A, 1B, 1C, and 1D decreases. Specifically, the CPU 400 corrects the peak-to-peak voltage Vpp of the developing bias, the blank time t1, the frequency of the AC voltage of the AC bias portion, and the amplitude or the duty ratio of the AC voltage of the AC bias portion such that the flying amount of the toner to the photosensitive drums 1A, 1B, 1C, and 1D decreases. Here, the frequency of the AC bias portion is the number of times of one waveform in one cycle of the developing bias. As a result, the flying amount of the external additive having the same potential as that of the toner to the photosensitive drums 1A, 1B, 1C, and 1D can be reduced, and the occurrence of a ghost image can be suppressed.

Specifically, the CPU 400 performs correction of decreasing the peak-to-peak voltage Vpp, decreasing the frequency of the AC voltage of the AC bias portion, decreasing the duty ratio (for example, setting 60% to 50%), decreasing the amplitude of the AC voltage of the AC bias, or increasing the blank time t1 in one cycle.

Here, by performing correction to lengthen the blank time t1 in one cycle, the time of the AC bias portion in one cycle of the developing bias can be reduced. As a result, the amount of the external additive flying together with the toner from the development devices 4A, 4B, 4C, and 4D to the photosensitive drums 1A, 1B, 1C, and 1D can be reduced.

In addition, it is possible to collect the toner flying to the photosensitive drums 1A, 1B, 1C, and 1D by performing correction to lengthen the blank time t1 during which the developing bias for collecting the toner from the photosensitive drums 1A, 1B, 1C, and 1D to the development devices 4A, 4B, 4C, and 4D is applied. As a result, since the external additive can be recovered together with the toner from the photosensitive drums 1A, 1B, 1C, and 1D, the amount of the external additive of the photosensitive drums 1A, 1B, 1C, and 1D can be reduced.

In addition, the number of times of causing the toner to fly from the development devices 4A, 4B, 4C, and 4D to the photosensitive drums 1A, 1B, 1C, and 1D can be reduced by performing correction to reduce the frequency of the AC bias portion. As a result, the amount of the external additive flying together with the toner from the development devices 4A, 4B, 4C, and 4D to the photosensitive drums 1A, 1B, 1C, and 1D can be reduced.

On the other hand, in a case where the correction is performed so that the flying amount of the toner to the photosensitive drums 1A, 1B, 1C, and 1D decreases, that is, in a case where the AC component of the developing bias is changed so as to decrease the developability, there is a possibility that the developing amount of the toner is insufficient and the image density decreases. However, in a case where the amount of the external additive of the toner to be supplied to the development devices 4A, 4B, 4C, and 4D is large, the adhesion amount of the external additive to the surface of the carrier in the developer increases, so that the charge application performance of the carrier to the toner decreases, and the charge amount of the toner decreases.

When the charge amount of the toner decreases, the electrostatic adhesion force between the carrier and the toner decreases, and the developing amount of the toner increases at the same developing bias as compared with the case where the external additive of the toner supplied to the development devices 4A, 4B, 4C, and 4D is small. Therefore, when the external additive coverage of the toner to be supplied to the development devices 4A, 4B, 4C, and 4D is large, even if the developing bias is corrected so that the developing amount of the toner decreases, a decrease in image density hardly occurs.

Next, the developing bias correction processing will be described in more detail with reference to FIG. 6.

The developing bias correction processing illustrated in FIG. 6 is started at timing when the image forming apparatus 100 detects that the developer replenishment container 91 is attached.

First, the external additive information determination portion 410 of the CPU 400 reads and acquires toner specific information stored in the developer replenishment container memory 90 (S101).

Next, the external additive information determination portion 410 of the CPU 400 acquires information on the toner external additive coverage included in the toner specific information (S102).

Next, the image forming condition calculation portion 420 of the CPU 400 determines the correction amount of the developing bias based on the information of the toner external additive coverage acquired by the external additive information determination portion 410 (S103).

For example, as illustrated in FIG. 13, when the toner external additive coverage is 61% (second ratio), the image forming condition calculation portion 420 performs correction to decrease the peak-to-peak voltage Vpp as compared with the case where the toner external additive coverage is 60% (first ratio). Alternatively, when the toner external additive coverage is 61%, the image forming condition calculation portion 420 performs correction to reduce the frequency of the AC voltage of the AC bias portion as compared with the case where the toner external additive coverage is 60%.

Alternatively, when an electric field in which the toner flies from the developing sleeve 41 side to the photosensitive drums 1A, 1B, 1C, and 1D side by the AC voltage is Vgo, an electric field in which the toner is pulled back from the photosensitive drums 1A, 1B, 1C, and 1D side to the developing sleeve 41 side by the AC voltage is Vre, an amplitude of the AC voltage is Vgo+Vre, and a duty ratio of the developing bias is Vgo/(Vgo+Vre), as illustrated in FIG. 13, when the external additive coverage of the toner is 61%, the image forming condition calculation portion 420 performs correction to reduce the duty ratio (Vgo/(Vgo+Vre)) (for example, 60% is set to 50%) as compared with the case where the external additive coverage of the toner is 60%.

Alternatively, when the toner external additive coverage is 61%, the image forming condition calculation portion 420 performs correction to lengthen the blank time t1 in one cycle as compared with the case where the toner external additive coverage is 60%. Alternatively, when the toner external additive coverage is 61%, the image forming condition calculation portion 420 performs correction to reduce the amplitude of the AC voltage of the AC bias portion as compared with the case where the toner external additive coverage is 60%.

For example, as illustrated in FIG. 13, when the toner external additive coverage is 59%, the image forming condition calculation portion 420 performs correction to increase the peak-to-peak voltage Vpp as compared with the case where the toner external additive coverage is 60%. Alternatively, when the toner external additive coverage is 59%, the image forming condition calculation portion 420 performs correction to increase the frequency of the AC voltage of the AC bias portion as compared with the case where the toner external additive coverage is 60%.

Alternatively, when an electric field in which the toner flies from the developing sleeve 41 side to the photosensitive drums 1A, 1B, 1C, and 1D side by the AC voltage is Vgo, an electric field in which the toner is pulled back from the photosensitive drums 1A, 1B, 1C, and 1D side to the developing sleeve 41 side by the AC voltage is Vre, an amplitude of the AC voltage is Vgo+Vre, and a duty ratio of the developing bias is Vgo/(Vgo+Vre), as shown in FIG. 13, when the external additive coverage of the toner is 59%, the image forming condition calculation portion 420 performs correction to increase the duty ratio (Vgo/(Vgo+Vre)) as compared with the case where the external additive coverage of the toner is 60%.

Alternatively, when the toner external additive coverage is 59%, the image forming condition calculation portion 420 performs correction to shorten the blank time t1 in one cycle as compared with the case where the toner external additive coverage is 60%. Alternatively, when the toner external additive coverage is 59%, the image forming condition calculation portion 420 performs correction to increase the amplitude of the AC voltage of the AC bias portion as compared with the case where the toner external additive coverage is 60%.

Next, the image forming condition calculation portion 420 of the CPU 400 applies the developing bias corrected by the determined correction amount to the development devices 4A, 4B, 4C, and 4D and executes the patch detection density control processing (S104), and then ends the developing bias correction processing. As described above, by executing the patch detection density control processing after determining the correction amount of the developing bias, it is possible to suppress the rapid variation in the image density before and after correcting the developing bias.

Here, the developing bias correction processing described above may not need to be executed depending on the environment or the like in which the image forming apparatus 100 is used. For example, in a case where the environment in which the image forming apparatus 100 is used is a humid environment, frictional charging between the toner and the carrier is less likely to occur, and the charging amount of the toner and the charging amount of the external additive decrease. As a result, an electric field for drawing toner generated by the external additives remaining on the photosensitive drums 1A, 1B, 1C, and 1D is reduced, and the ghost image is hardly generated.

Based on the above fact, the image forming apparatus 100 may switch between the operation of performing the developing bias correction processing by the controller 11 and the operation of not performing the developing bias correction processing by the operation by the user via the operation portion 12. In this case, the CPU 400 executes the developing bias correction processing when the operation is switched to the operation of performing the developing bias correction processing by the operation portion 12. In addition, the CPU 400 does not execute the developing bias correction processing when the operation is switched to the operation of not executing the developing bias correction processing by the operation portion 12.

### <Patch Detection Density Control Processing>

The patch detection density control processing executed by the image forming apparatus 100 according to the first embodiment of the present disclosure will be described in detail.

By executing the patch detection density control processing, the CPU 400 sets the laser light quantities of the exposure devices 3A, 3B, 3C, and 3D so as to obtain an appropriate image density in the correction amount of the developing bias determined by the processing of step S103 of the developing bias correction processing.

At this time, the reflective density sensor 140 detects the density of the patch image formed by changing the light quantity of the laser emitted from the exposure devices 3A, 3B, 3C, and 3D in five stages. In addition, the CPU 400 obtains a linear function obtained by linearly interpolating the light quantity of the laser emitted from the exposure devices 3A, 3B, 3C, and 3D on the X-axis and the density of the patch image detected by the reflective density sensor 140 on the Y-axis. Then, based on the obtained linear function, the CPU 400 determines the light quantity of the laser that becomes the predetermined target density of the patch image, and performs control to emit the laser of the light quantity determined by the exposure devices 3A, 3B, 3C, and 3D at the time of the image forming processing.

Here, the reason why both specular reflection and diffuse reflection are detected in the reflective density sensor 140 will be described.

In the high density toner patch T in which the toner applied amount is large, a specular reflection P wave tends to decrease and saturate. The light quantity of diffuse reflection S waves at this time tends to maintain linearity. On the other hand, in the low density toner patch T in which the toner applied amount is small, a diffuse reflection S wave tends to decrease and saturate. The light quantity of the specular reflection P wave at this time tends to maintain linearity. Therefore, in order to accurately detect both the low-density toner patch T and the high-density toner patch T, it is desirable to perform calculation using both specular reflection P waves and diffuse reflection S waves in combination.

The light quantity suitable for detecting the toner adhesion amount of the toner patch T is a light quantity with which favorable sensitivity can be obtained for both low density with a small toner adhesion amount and high density with a large toner adhesion amount. The absolute value of the reflected light quantity of the toner patch T in which the toner adhesion amount is low density decreases as the light quantity of light applied to the toner patch T decreases, and there is a tendency that it becomes difficult to distinguish the reflected light quantity from the gloss unevenness of the surface of the intermediate transfer belt 62. On the other hand, the absolute value of the reflected light quantity of the toner patch T having a high toner adhesion amount tends to be less sensitive to a change in the density of the toner adhering to the toner patch T as the light quantity applied to the toner patch T is increased.

Therefore, the light quantity suitable for detecting the toner adhesion amount of the toner patch T is desirably a level at which the light quantity of the reflected light from the toner patch T having a low toner adhesion amount can be distinguished from the gloss unevenness of the surface of the intermediate transfer belt 62. In addition, the light quantity suitable for detecting the toner adhesion amount of the toner patch Tis desirably a level at which the light quantity of the reflected light from the toner patch T having a high toner adhesion amount has favorable sensitivity to the density change of the toner adhering to the toner patch T.

In this manner, the CPU 400 adjusts the amount of reflected light from the surface of the intermediate transfer belt 62 on which no toner image is formed to a target appropriate light quantity level. For example, the CPU 400 adjusts the light quantity level so that the average reflected light quantity for one round of the surface of the intermediate transfer belt 62 becomes 3.5±0.05 [V]. By adjusting the average reflected light quantity, even when the glossiness of the surface of the intermediate transfer belt 62 changes due to durability, it is possible to correctly control the glossiness.

### <Effect of Preventing Occurrence of Ghost Image>

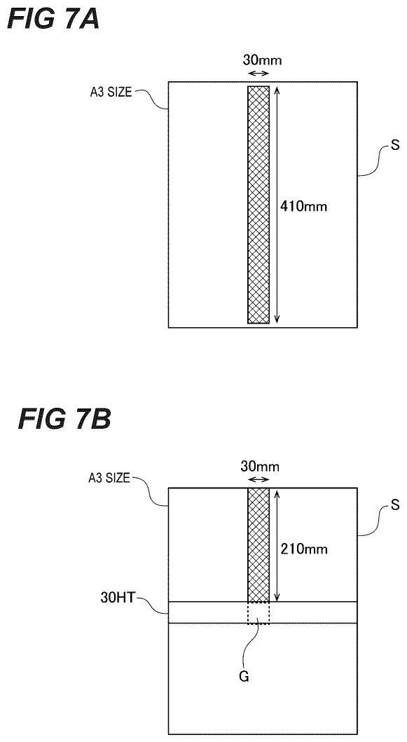

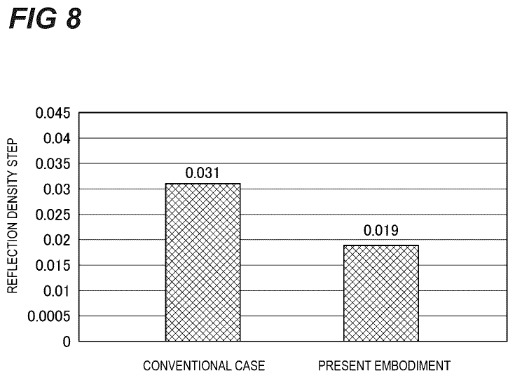

An effect of preventing occurrence of a ghost image in the image forming apparatus 100 according to the first embodiment of the present disclosure will be described in detail with reference to FIGS. 7A to 8.

In the image forming apparatus 100, an image having an image ratio of 30% was formed on an A4 size sheet S while a developer having a toner external additive coverage of 64% was supplied in advance, and 200 sheets were output. Thereafter, as shown in FIG. 7A, vertical bands having an image ratio of 100% with a main scanning width of 30 mm and a sub-scanning width of 410 mm were formed on the A3 size sheet S, and 5 sheets were output.

Thereafter, one sheet S on which the image illustrated in FIG. 7B was formed was output. Then, the reflection density of the overlapping portion G in the region surrounded by the dotted line immediately after the vertical band solid image in the halftone image of 30HT and the non-overlapping portion where no solid image was formed immediately before the halftone image of 30HT was measured by the reflective density sensor 140. Further, a reflection density difference between the overlapping portion G and the non-overlapping portion was obtained, and the obtained reflection density difference was calculated as a halftone reflection density step (=ghosting severity).

The reflection density step was compared between the case where the peak-to-peak voltage Vpp of the developing bias was corrected by −0.2 kV to 1.2 kV at the time of image formation and the case where the peak-to-peak voltage Vpp of the developing bias was not corrected and 1.4 kV. As a result of the comparison, as illustrated in FIG. 8, in each image ratio, the reflection density step in the case of the correction illustrated as the present embodiment was smaller than the reflection density step in the case of the non-correction illustrated as the conventional case. Therefore, it can be seen that the ghost is improved in the case of the correction as compared with the case of the non-correction.

The present embodiment includes the developer replenishment container memory 90 that is provided in the developer replenishment container 91 and stores information on the coverage of the external additive carried on the surface of the toner contained in the developer replenishment container 91. In addition, the present embodiment includes the controller 11 that corrects the developing bias based on the information stored in the developer replenishment container memory 90. As a result, it is possible to provide the image forming apparatus 100 capable of performing good image formation even when the amount of the external additive (coverage of external additive) carried on the surface of the toner varies depending on the lot at the time of manufacturing the toner.

### Second Embodiment

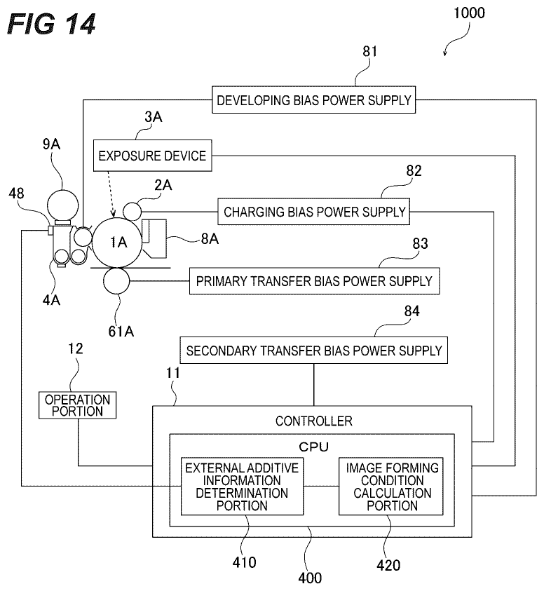

A configuration of an image forming apparatus 1000 according to a second embodiment of the present disclosure will be described in detail with reference to FIG. 14.

Note that, in FIG. 14, portions having the same configurations as those in FIG. 4 are denoted by the same reference numerals, and description thereof is omitted.

The image forming apparatus 1000 includes photosensitive drums 1A, 1B, 1C, and 1D, charging rollers 2A, 2B, 2C, and 2D, exposure devices 3A, 3B, 3C, and 3D, development devices 4A, 4B, 4C, and 4D, and a fixing device 7. The image forming apparatus 1000 includes cleaners 8A, 8B, 8C, and 8D, supply devices 9A, 9B, 9C, and 9D, a controller 11, an operation portion 12, a development device memory 48, and primary transfer rollers 61A, 61B, 61C, and 61D. Further, the image forming apparatus 1000 includes an intermediate transfer belt 62, a secondary transfer portion 65, a developing bias power supply 81, a charging bias power supply 82, a primary transfer bias power supply 83, a secondary transfer bias power supply 84, and a reflective density sensor 140.

Although the photosensitive drums 1B, 1C, and 1D and the charging rollers 2B, 2C, and 2D are not illustrated in FIG. 14, the photosensitive drums 1B, 1C, and 1D and the charging rollers 2B, 2C, and 2D have the same configuration as the photosensitive drum 1A and the charging roller 2A. The same applies to the exposure devices 3B, 3C, and 3D, the development devices 4B, 4C, and 4D, the cleaners 8B, 8C, and 8D, the supply devices 9B, 9C, and 9D, and the primary transfer rollers 61B, 61C, and 61D.

The development device memory 48 as a storage portion is provided for each color of toner stored in the development devices 4A, 4B, 4C, and 4D. The development device memory 48 is an IC chip, a bar code, or the like.

The development device memory 48 can communicate with an information reading portion (not illustrated) of the image forming apparatus 1000. In the development device memory 48, data is read and written by the CPU 400 of the controller 11 via the information reading portion. The development device memory 48 stores unique information of toners (toner in initial developer) stored in the developing containers 44 of the development devices 4A, 4B, 4C, and 4D.

The external additive information determination portion 410 of the CPU 400 of the controller 11 acquires information unique to the toner (toner in initial developer) from the development device memory 48 by reading the information through an information reading portion (not illustrated) of the image forming apparatus 1000.

Note that the developing bias correction processing executed by the image forming apparatus 1000 according to the second embodiment is the same processing as that in FIG. 6, and thus the description thereof will be omitted.

The present embodiment includes a development device memory 48 that is provided in the development devices 4A, 4B, 4C, and 4D and stores information unique to the toner (toner in initial developer) stored in the developing container 44, and a controller 11 that corrects the developing bias based on the information stored in the development device memory 48. As a result, it is possible to provide the image forming apparatus 1000 capable of performing good image formation even when the amount of the external additive (coverage of external additive) carried on the surface of the toner varies depending on the lot at the time of manufacturing the toner (toner in initial developer).

In the present embodiment, the developer replenishment container memory 90 is not provided, but the present invention is not limited thereto, and the developer replenishment container memory 90 may be provided. In this case, the CPU 400 performs the same processing and operation as those of the first embodiment based on toner specific information stored in the developer replenishment container memory 90.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Specifically, in the first and second embodiments, the peak-to-peak voltage Vpp of the developing bias, the blank time t1, and the frequency or duty ratio of the AC bias portion are corrected so that the flying amount of the toner to the photosensitive drums 1A, 1B, 1C, and 1D decreases. However, the present invention is not limited thereto, and any two or more of the peak-to-peak voltage Vpp of the developing bias, the blank time t1, the frequency of the AC bias portion, and the duty ratio may be corrected so that the flying amount of the toner to the photosensitive drums 1A, 1B, 1C, and 1D decreases.

According to the present disclosure, occurrence of image defects can be suppressed even when the coverage of the external additive carried on the surface of the toner varies.

This application claims the benefit of Japanese Patent Application No. 2024-179625, filed Oct. 15, 2024 which is hereby incorporated by reference herein in its [or their, if more than one] entirety.

What is claimed is:

1. An image forming apparatus comprising:
an image bearing member;
a developing container that accommodates a developer containing a toner;
a developer bearing member that carries the developer accommodated in the developing container;
a developing bias application portion that applies a developing bias in which an AC voltage and a DC voltage are superimposed on the developer bearing member in order to develop an electrostatic latent image formed on the image bearing member by the developer carried on the developer bearing member;
a toner replenishment container that accommodates a toner to be supplied to the developing container;
an acquisition portion that acquires information on a coverage of an external additive carried on a surface of the toner accommodated in the toner replenishment container; and
a controller that controls the developing bias application portion based on the information on the coverage acquired by the acquisition portion.

2. The image forming apparatus according to claim 1, wherein
the toner replenishment container is provided with a storage portion that stores information on the coverage of the external additive carried on the surface of the toner contained in the toner replenishment container, and
the acquisition portion acquires the information on the coverage from the storage portion provided in the toner replenishment container.

3. The image forming apparatus according to claim 1, wherein
a charging polarity of the external additive is the same polarity as a charging polarity of the toner, and
the controller controls the developing bias application portion such that an amplitude of the AC voltage in a case where the coverage is a second ratio higher than a first ratio is smaller than an amplitude of the AC voltage in a case where the coverage is a first ratio.

4. The image forming apparatus according to claim 1, wherein
a charging polarity of the external additive is the same polarity as a charging polarity of the toner, and
the controller controls the developing bias application portion such that a frequency of the AC voltage in a case where the coverage is a second ratio higher than a first ratio is smaller than a frequency of the AC voltage in a case where the coverage is a first ratio.

5. The image forming apparatus according to claim 1, wherein
a charging polarity of the external additive is the same polarity as a charging polarity of the toner, and
when an electric field in which the toner flies from the developer bearing member side to the image bearing member side by the AC voltage is Vgo, an electric field in which the toner is drawn back from the image bearing member side to the developer bearing member side by the AC voltage is Vre, an amplitude of the AC voltage is Vgo+Vre, and a duty ratio of the developing bias is Vgo/(Vgo+Vre), the controller controls the developing bias application portion such that the duty ratio in a case where the coverage is a second ratio higher than a first ratio is lower than the duty ratio in a case where the coverage is the first ratio.

6. The image forming apparatus according to claim 1, wherein
a charging polarity of the external additive is the same polarity as a charging polarity of the toner,
the developing bias has a waveform including, as one cycle, an AC bias portion in which the AC voltage and the DC voltage are superimposed, and a blank portion including only the DC voltage subsequent to the AC bias portion, and
the controller controls the developing bias application portion such that a time of the blank portion in one cycle of the developing bias in a case where the coverage is a second ratio higher than the first ratio is longer than a time of the blank portion in one cycle of the developing bias in a case where the coverage is the first ratio.

7. An image forming apparatus comprising:
an image bearing member;
a development device including a developing container that accommodates a developer containing toner and a developer bearing member that carries the developer accommodated in the developing container;
a developing bias application portion that applies a developing bias in which an AC voltage and a DC voltage are superimposed on the developer bearing member in order to develop an electrostatic latent image formed on the image bearing member by the developer carried on the developer bearing member;
an acquisition portion that acquires information on a coverage of an external additive carried on a surface of the toner accommodated in the development device; and
a controller that controls the developing bias application portion based on the information on the coverage acquired by the acquisition portion.

8. The image forming apparatus according to claim 7, wherein the development device is provided with a storage portion that stores information on the coverage of the external additive carried on the surface of the toner contained in the developing container, and
the acquisition portion acquires the information on the coverage from the storage portion provided in the development device.

9. The image forming apparatus according to claim 7, wherein
a charging polarity of the external additive is the same polarity as a charging polarity of the toner, and
the controller controls the developing bias application portion such that an amplitude of the AC voltage in a case where the coverage is a second ratio higher than a first ratio is smaller than an amplitude of the AC voltage in a case where the coverage is a first ratio.

10. The image forming apparatus according to claim 7, wherein
a charging polarity of the external additive is the same polarity as a charging polarity of the toner, and
the controller controls the developing bias application portion such that a frequency of the AC voltage in a case where the coverage is a second ratio higher than a first ratio is smaller than a frequency of the AC voltage in a case where the coverage is a first ratio.

11. The image forming apparatus according to claim 7, wherein
a charging polarity of the external additive is the same polarity as a charging polarity of the toner, and
when an electric field in which the toner flies from the developer bearing member side to the image bearing member side by the AC voltage is Vgo, an electric field in which the toner is drawn back from the image bearing member side to the developer bearing member side by the AC voltage is Vre, an amplitude of the AC voltage is Vgo+Vre, and a duty ratio of the developing bias is Vgo/(Vgo+Vre), the controller controls the developing bias application portion such that the duty ratio in a case where the coverage is a second ratio higher than a first ratio is lower than the duty ratio in a case where the coverage is the first ratio.

12. The image forming apparatus according to claim 7, wherein
a charging polarity of the external additive is the same polarity as a charging polarity of the toner,
the developing bias has a waveform including, as one cycle, an AC bias portion in which the AC voltage and the DC voltage are superimposed, and a blank portion including only the DC voltage subsequent to the AC bias portion, and
the controller controls the developing bias application portion such that a time of the blank portion in one cycle of the developing bias in a case where the coverage is a second ratio higher than the first ratio is longer than a time of the blank portion in one cycle of the developing bias in a case where the coverage is the first ratio.
